(19) United States
(12) Patent Application Publication
(10) Pub. No.: US 2021/0333786 A1
(43) Pub. Date: Oct. 28, 2021

(54) Apparatus and Method for Immersive Computer Interaction

(71) Applicant: Siemens Aktiengesellschaft, Muenchen (DE)

(72) Inventors: Daniel Krüger, Roth (DE); Tobias KÖDEL, Bayreuth (DE); Wolfgang WOHLGEMUTH, Erlangen (DE)

(21) Appl. No.: 17/239,806

(22) Filed: Apr. 26, 2021

(30) Foreign Application Priority Data
Apr. 27, 2020 (EP) 20171528

(51) Int. Cl. G05B 19/418; G05B 19/4069; G05B 19/05; G05B 17/02

(52) U.S. Cl. CPC G05B 19/41885; G05B 19/4069; G05B 2219/40356; G05B 17/02; G05B 2219/40131; G05B 19/05

(57) ABSTRACT

Methods and an arrangement for immersive human computer interaction with a virtual mechanical operator of an industrial automation arrangement in virtual reality, wherein input information is transmitted to a component of the arrangement through the interaction with the virtual operator modelled in a simulation device for a rigid-body simulation, where the virtual operator is replicated in the virtual reality, an interaction with the represented virtual operator is detected by the virtual reality environment, second parameters calculated from first parameters of the detected virtual interaction are transmitted to the simulation device and used via the modelled virtual operator to simulate movement of a part of the operator, whether a switching state change of the virtual operator is produced by the simulated movement is decided, and where the switching state or the switching state change is reported as the input information to the component at least when a switching state change occurs.

### BACKGROUND OF THE INVENTION

### 1. Field of the Invention

The invention relates to an arrangement and method for immersive human computer interaction with a virtual mechanical operator of an industrial automation arrangement in a virtual reality.

### 2. Description of the Related Art

Immersive technologies, such as Virtual and Augmented Reality (VR, AR), or virtual environments, such as CAVE (Cave Automatic Virtual Environment), are becoming increasingly important in the industrial sector also. Immersive means that the virtual reality is largely perceived as real. In particular, the interactive visualization of machines in a virtual reality, in particular the user interface and the operator of the machines and the machine controls or the operating and monitoring devices used therein enable highly promising applications.

In virtual commissioning, control programs and a parameterization of the machine or the associated industrial automation components (programmable logic controllers, or operating and monitoring devices) are tested in a simulation environment prior to the programming or loading onto the real machine to detect faults at an early stage and prevent possible consequential damage. In virtual training, operating personnel learn how to handle a machine via a machine simulation to reduce training time and outage times of the real machine. Virtual user tests are used to optimize the usability of machines or industrial arrangements.

In this context, possibilities must be found for providing the human-machine interface and therefore the interactions between the human and the machine as realistically as possible within the immersive environment (e.g., virtual reality headset). In particular, training applications require the user to encounter the same interaction metaphors as those subsequently encountered on the real machine.

In current conventional systems, the human-machine interaction is simulated in virtual reality (VR) or augmented reality (AR) usually via predefined interaction routines, such as scripts. These are fully defined in the system that creates the virtual reality. If, for example, a pushbutton is to be replicated, its kinematic behavior (e.g., movability) is permanently programmed in the system for the virtual reality and is triggered by the user via a corresponding input (e.g., pressing a button on a virtual reality controller, i.e., a type of remote control). An event is consequently triggered by the virtual reality system, where the event is frequently directly linked to a technical function of the machine or of an operating and monitoring device. In the example mentioned, it is therefore detected, for example, that a button has been actuated and a forward feed is therefore activated or the like. The logical connection of the human-machine interface with the machine control is implemented once more here by the virtual reality system, i.e., an aspect of the machine design is implemented in duplicate for visualization purposes.

This additional engineering complexity is frequently shunned. As a result, the possibilities for interaction in commercially implemented industrial virtual reality systems are mostly very restricted.

The integration of these scripts and the definition of the interaction between a user and the operator (e.g., pushbutton) in the virtual reality system further has the disadvantage that, in the event of a modification of the simulated devices and therefore the real operator, the virtual reality system must also be adapted every time.

### SUMMARY OF THE INVENTION

In view of the foregoing, it is therefore an object of the present invention to provide an arrangement and method for realistic simulation of human-machine interaction in immersive environments where, on one hand, the engineering complexity is reduced and where, on the other hand, a mechanical operator is operable as realistically as possible in the virtual reality.

A core idea of the achievement of the present object in accordance with the invention is that a strict separation of the machine simulation and the machine visualization, i.e., the virtual reality system, is maintained, where a generic handling of mechanical operating elements occurs through a physical mediation or simulation of the interaction, and where, if necessary, the display screen output of operating and monitoring systems (Human-Machine Interface (HMI) systems) is integrated into the machine visualization.

These and other objects and advantages are achieved in accordance with the invention by an arrangement and method for immersive human computer interaction with a virtual mechanical operator of an industrial automation arrangement in a virtual reality, where input information is transmitted to a component of the industrial automation arrangement through the interaction with the virtual mechanical operator. In a first step, the virtual mechanical operator is modelled in a simulation device for a rigid-body simulation, where, in a second step, the virtual mechanical operator is replicated in the virtual reality, where, in a third step, an interaction with the represented virtual mechanical operator is detected by the virtual reality, where second parameters relating to a simulated physical effect on the virtual mechanical operator are calculated from first parameters of the detected virtual interaction, where, in a fourth step, the second parameters are transmitted to the simulation device, where, in a fifth step, the second parameters are used by the simulation device via the modelled virtual mechanical operator to simulate a movement of at least a part of the virtual mechanical operator, where it is decided whether a switching state change of the virtual mechanical operator is produced by the simulated movement, and where, in a sixth step, the switching state or the switching state change is reported as the input information to the component, at least in the case of a switching state change. A strict separation of machine simulation and machine visualization is guaranteed by the method in accordance with the invention. This results in increased flexibility in terms of the use of different immersive environments (VR headset, CAVE, tablet, AR headset), in a better distribution of the computing load among a plurality of nodes and in improved data consistency, because the machine behavior is described uniformly in design systems, where the machine know-how remains in the simulation environment, i.e., in the engineering system. Interactive optimizations in terms of accessibility and usability of the machine can be more easily performed in the virtual reality due to this separation.

It is also an object of the invention to provide an arrangement for immersive human computer interaction with a virtual mechanical operator of an industrial automation arrangement in a virtual reality, where the arrangement is configured to transmit input information to a component of the industrial automation arrangement as a result of the interaction with the virtual mechanical operator, with a system for creating and visualizing the virtual reality, and where the virtual mechanical operator is replicated in the virtual reality. A simulation device for a rigid-body simulation of the virtual mechanical operator is provided, where the virtual reality is configured to detect an interaction with the represented virtual mechanical operator, where it is provided, from first parameters of the detected virtual interaction, to calculate second parameters relating to a simulated physical effect on the virtual mechanical operator, where the virtual reality is configured to transmit the second parameters to the simulation device, where the simulation device is configured to simulate a movement of at least a part of the virtual mechanical operator via the modelled virtual mechanical operator based on the second parameters, where the simulation device is configured to decide whether a switching state change of the virtual mechanical operator is produced by the simulated movement, and where the simulation device, at least in the case where the switching state change occurs, is configured to report the switching state change or the switching state as the input information to the component. The advantages already discussed with reference to the method can be achieved with this arrangement.

In the simulation, a simulated mass-comprising body, in particular a lever or button or switch or other movable element, is advantageously used as the at least one part of the virtual mechanical operator. In contrast to bodies of mechanical operators comprising no mass, such as softkeys on user interfaces, sensor buttons, light barriers or the like, the operating behavior of many real mechanical operators is more readily replicable. In particular, operating errors that can occur as a result of accidental contact are thus reduced. Whereas, in the prior art, it is necessary for a person to take hold of a real operator, i.e., a virtual reality controller such as a controller for games consoles or the like, in order to replicate buttons, etc., of this type, the kinetics of a mechanical solution can be realistically replicated through the simulation of a mass-comprising body. At least a force or a force-torque pair or other kinetic interaction dynamic is applied as the second parameters to the simulated mass-comprising body. The virtual operating action can be further approximated to the real operating action by determining first values for a direction and a penetration of a virtual hand or virtual finger or other body part as the first parameters via the virtual reality with the replicated virtual mechanical operator, where the second parameters are then calculated from these first values in order to calculate the simulated effect on the simulated mass-comprising body.

If the industrial automation arrangement comprises a device with a display screen output, then the geometry of this device is also replicated in the virtual reality. The display screen output is generated in the simulation environment of the industrial automation arrangement, in particular by a simulation of an operating and monitoring device (HMI emulation) and is transmitted to the virtual reality, for example, in the form of an image file, stream or the like (pixel buffer) for a finished video texture, and is represented there in the represented housing geometry or the represented display screen surface of a virtually represented operating and monitoring device. This means that a realistic simulation of an operating and monitoring device or even a real operating and monitoring device can generate the display screen output with its original program code so that only a housing, for example, a panel or other industrial operating station, has to be simulated within the virtual reality, and the virtual reality can obtain the display screen content from outside as an image and can output it on the represented housing. The virtual reality is therefore not used in this advantageous embodiment for the generation of the display screen output or its content; this can be obtained instead from a specialized simulation system or even from a real unit.

The device with the display screen output can thus be either a real or a simulated operating and monitoring device, where inputs from the virtual reality and/or the input parameters generated from the kinetic rigid-body simulation and/or state information of a simulated industrial process are used for the real or simulated operating and monitoring device, where outputs of the real or simulated operating and monitoring device are forwarded to the virtual reality and are represented there with or in a replication of the operating and monitoring station. If a real operating and monitoring device is incorporated into the simulation of the industrial automation arrangement, this is also referred to as a hardware-in-the-loop integration. This means that a real system is linked to a simulation system, which is useful, particularly in those systems that comprise hardly any mechanical elements, which is normally the case with the computers for operating and monitoring tasks.

In one advantageous embodiment, a virtual (emulated or simulated) programmable logic controller can be used as the component, where the virtual programmable logic controller executes an automation program intended for a real automation arrangement and where change requirements identified in the execution of the program in the virtual programmable logic controller are used to correct the automation program, and where the changed automation program is used in the real automation arrangement. The experiences gained through the operation of the simulated system via the virtual reality can result in an improvement in the automation program so that a real automation arrangement operated therewith is optimized.

In one advantageous embodiment, a simulation device for an industrial process or an industrial production is connected to the virtual programmable logic controller, wherein, via a bidirectional data exchange, the virtual programmable logic controller controls and/or monitors an industrial process simulated therewith or an industrial production simulated therewith.

In one advantageous embodiment, the second parameters or third parameters are transmitted by the simulation device for the rigid-body simulation via the simulated movement to the virtual reality, whereby a representation of the virtual mechanical operator is adapted based on the transmitted parameters. It is therefore possible to represent the movement of a mechanical operator, such as a pushbutton, lever or switch, realistically in the virtual reality. The advantage here is that a user obtains direct visual, and possibly even audible, feedback through his operating action on the virtual mechanical operator. This is advantageous, particularly in those systems that are built for training purposes, because a complex operating pattern can be trained completely and realistically (“immersively”) therewith.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An example embodiment of the invention will be explained below with reference to the drawings, in which:

FIG. 1 is an exemplary embodiment of the arrangement in accordance with the invention; and

FIG. 2 is a flowchart of the method in accordance with the invention.

### DETAILED DESCRIPTION OF THE EXEMPLARY EMBODIMENTS

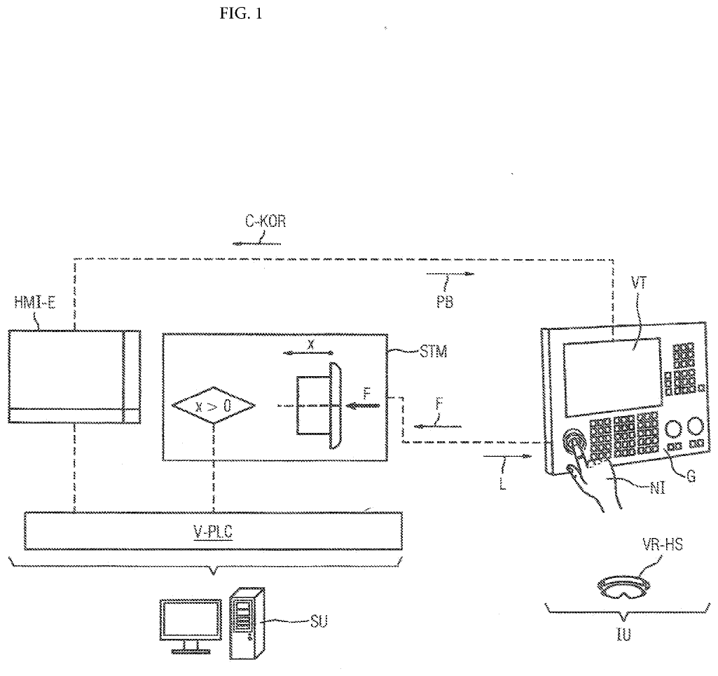

FIG. 1 shows a schematic view of a virtual reality with a represented industrial operating panel with a virtual mechanical or electromechanical operator and a simulation environment with a rigid-body simulation, a virtual control and an emulation of an operating and monitoring device.

In FIG. 1, a simulation environment SU is shown on the left-hand side which, in the present example of a simulation device for a rigid-body simulation STM, comprises an emulation of an operating and monitoring device HMI-E (Human Machine Interface (HMI) emulation) and a simulated programmable logic controller Virtual Programmable Logic Controller (V-PLC). As shown, the aforementioned three units can run as individual processes on a shared hardware platform, but they can also be completely separate systems which communicate via a data network. In particular, it is also possible to implement individual or all shown simulation devices in a data cloud. In addition, it is also possible to replace, in particular, the virtual programmable logic controller V-PLC and/or the emulation of the operating and monitoring device HMI-E with non-simulated programmable logic controllers or operating and monitoring devices; this is then referred to as a hardware-in-the-loop arrangement.

On the right-hand side of FIG. 1, an immersive environment IU is shown, i.e., an environment in which a user can create realistic virtual experiences, in particular can experience the operation of components of an industrial automation arrangement. In the present example, the immersive environment IU consists of a special computer system (not shown) for creating a virtual reality, data glasses VR-HS (Virtual Reality Headset), means (not shown) for detecting the movement of a hand or further body parts and a space for movement (not shown here). The computer system for creating the immersive environment IU is designed separately from the simulation environment SU; only data connections between the two systems exist.

The schematic view is reduced to the bare essentials. In particular, the virtual programmable logic controller V-PLC normally has a data connection to a further simulation system for an industrial process or industrial production which is to be controlled and monitored. The simulation environment SU is configured such that an industrial automation arrangement is functionally sufficiently fully replicated and an operation of the industrial automation arrangement can be performed in a simulation.

For the representation of the industrial automation arrangement in the virtual reality (immersive environment IU), it is assumed that most elements of the automation environment already exist in the sense of a digital twin supporting the design as a simulation model for a simulation environment SU, whereby all technologically relevant aspects of the machines or elements can be replicated by corresponding simulators. This relates to the geometry, i.e., the geometric description of a machine, such as in the form of data, including the operating devices (panels or switches), and including a multibody simulation for rigid-body mechanics, where the simulation of the movement of all mechanical components of the machine is possible under the influence of active forces. This also comprises the kinetics of mechanical operating elements such as pushbuttons or adjusting wheels. It is further assumed that the graphical user interface of the operating system can be simulated and therefore created with the simulation for the operating and monitoring device HMI-E. The virtual programmable logic controller V-PLC simulates the running behavior of all control programs of a machine or arrangement. It therefore also communicates with the multibody simulation, in particular the rigid-body simulation STM, the emulated operating and monitoring device HMI-E and the simulation (not shown) for the industrial process or industrial production.

The immersive environment IU is responsible for the graphical representation (rendering) of the machine model and the processing of general user inputs NI (user interaction), tracking of hand and head position (in particular as cursor coordinates C-KOR) and the representation of feedback (in particular changed position L of a represented operator), whereas all aspects of the operating behavior of a machine, including the human-machine interface and therefore the representation of an operating and monitoring device are replicated within the simulation environment SU. For the visualization, the geometric description of the machine (geometry G) is transmitted in reduced form to the immersive environment IU and is represented there, in the present exemplary embodiment as the housing of an operating panel.

With regard to the human computer interaction, a distinction is made between mechanical operating elements (levers, buttons, rotary controls) and virtual operating elements (e.g., softkeys on an operating display screen) and displays and the like.

A human computer interaction, i.e., a user interaction NI, of a finger of a user detected in the immersive environment IU with an operator will be explained below by way of example. The operator is, by way of example, a pushbutton, such as an emergency stop button that is shown on the bottom left of FIG. 1 in the form of a circle on the geometry G of an operating panel represented in the immersive environment IU.

As soon as the immersive environment IU identifies a collision or penetration of the finger of the user with the represented operator, first parameters of the detected virtual interaction are established. This can be, for example, the direction and the “depth” of the penetration. Second parameters relating to the simulated physical effect on the operator are calculated from these first parameters. This means that a force F, for example, is determined from the movement of the interaction NI. This can occur, for example, if a proportional force F is determined by the virtual operating path, i.e., the penetration of the operator with the finger. However, kinetics can also be assumed, so that a speed of the actuation procedure can also be included proportionally in the force F or an assumed momentum (not used here) or the like.

An identification of the operator and the second parameters (here, for example: force F) are then transmitted from the immersive environment IU, i.e., the specialized computer system for the virtual reality, to the simulation environment SU and therein specifically to the simulation device for a rigid-body simulation STM.

Mechanical operating elements or operators occur in the rigid-body simulation STM as mass-comprising bodies that can be moved due to the application of forces and torques according to their kinematic degrees of freedom (rotation, translation). The switching logic of the operator considered here, i.e., the pushbutton, can therefore be expressed depending on the current position of the button body. For this purpose, the mechanical operator for the simulation device STM is modelled using data technology, for example, as a simulation-enabled digital twin, as an equation system, or as a simulation object. In the rigid-body simulation STM, the operator or a moving part thereof is then confronted with the second parameters, i.e., the force F determined from the operating procedure or a momentum or the like is applied to the mass-comprising, simulated body of the operator and any spring connected thereto, latching elements or the like.

As a result, the rigid-body simulation STM calculates a movement of the operator, in the case shown here of the pushbutton, i.e., a movement of the button head, which is represented by the coordinate X in FIG. 1. If the calculated movement (coordinate X) exceeds a threshold value (here: X>0), it is decided that the operator has changed its state, which specifically means that the switch has tripped or an “emergency stop” has been pressed. This switching state change or generally the currently valid switching state of the operator is transmitted, by way of example, to the virtual programmable logic controller V-PLC and is signaled there on a (virtual) input.

An automation program which, for example, controls a production station, can execute in the virtual programmable logic controller V-PLC. As soon as the switching state change is signaled on this controller V-PLC, the automation program then responds accordingly, such as by implementing an emergency stop. Corresponding information relating to the new “emergency stop” state of the automation program is transmitted to the emulated operating and monitoring device HMI-E also. This results in a changed display screen output of the operating and monitoring device HMI-E, where, for example, a red stop signal is now output on the display screen or the like. The changed display screen output is processed to provide changed image data or changed partial image data. These image data will be referred to below as the pixel buffer PB. The pixel buffer PB is transmitted to the immersive environment IU and is represented there as a video texture VT on a display screen area of the represented geometry G such that a user of the immersive environment IU has the impression of being confronted with an actual operating panel with the geometry G and the display screen content of the pixel buffer PB. Cursor coordinates C-KOR and corresponding registered inputs, such as touches on a virtual touchscreen, can be transmitted to the emulated operating and monitoring device HMI-E for the processing of further inputs on the represented operating panel.

The virtual programmable logic controller V-PLC can further forward information to a simulation (not shown) of an industrial process according to the example chosen here, indicating that the simulated industrial process is stopped. If this does not occur correctly in the simulation, there may possibly be an error in the automation program that is executed by the virtual programmable logic controller V-PLC. The automation program can then be optimized until a correct function occurs. The automation program optimized in this way can then be used in a real automation arrangement for correction purposes.

Through the rigid-body simulation STM, the switching logic of the pushbutton can therefore be expressed depending on the current position of the button body and can be fed to the virtual programmable logic controller V-PLC, for example, as a Boolean signal (or alternatively as an analog or digital signal proportional to the deflection X). Viewed from outside, the machine function is therefore triggered by the application of a compressive force on the button body, which corresponds exactly to the real expectation of a user. On the side of the immersive environment IU, it therefore suffices to determine a force-torque pair that is transmitted to the simulation environment SU and specifically to the rigid-body simulation STM, where it is applied to the correspondingly replicated rigid body. The position change of the operating element resulting therefrom is later communicated back to the immersive environment IU for visualization. This means that the represented operator then changes its position accordingly in the representation also, in order to provide the user with corresponding feedback. This interaction dynamic can be determined from the tracked hand movements of the user, taking into account the proximity to the geometric representation of the operating element in the sense of a collision analysis.

Virtual operating elements (e.g., GUI widgets, sensor buttons, or virtual buttons) form part of the operating display screen of the represented geometry and are handled within the simulation environment SU through the emulation of the operating and monitoring device HMI-E. Generally speaking, this emulation HMI-E consumes these input events from a pointing device (cursor coordinates C-KOR, button presses of a mouse, or touch inputs) and renders the display screen output into a pixel buffer PB that would be shown on a real machine on a display (HMI panel) in the form of a display screen output (video texture). In order to implement this behavior on the side of the immersive IU, the pixel buffer PB is transmitted in a demand-driven manner from the simulation environment SU to the immersive environment IU and is integrated there into the representation of the machine geometry (geometry G) in the form of a video texture VT. Conversely, the input events (cursor coordinates C-KOR, button presses) necessary for the interaction are similarly generated from the body movements of the user and/or suitable interaction facilities of the virtual reality hardware (e.g., controllers) and are transmitted via the network to the simulation environment SU.

The strict separation of machine simulation and machine visualization creates increased flexibility in terms of different immersive environments (VR headset, CAVE, tablet, AR headset). It is additionally possible to distribute the computing load among a plurality of nodes. Data consistency is improved because the machine behavior is described uniformly in a design system, where the know-how remains in the simulation environment, specifically in the underlying engineering system with which the software and the hardware of the simulated industrial automation arrangement have been planned.

The physical mediation of the human computer interaction through forces/torques (interaction dynamic) enables a highly generic handling of mechanical operating elements. In particular, no information relating to functional aspects of the machine design which, in some instances, would have to be modelled manually needs to be present on the side of the immersive environment. Depending on the requirement for the precision of the physical simulation, the operating elements further behave exactly as in reality, from which training applications benefit. Due to the embedding of the HMI emulation in the three-dimensionally visualized machine geometry (video texture), entire HMI systems can further be realistically replicated, where the requirement to transport no information relating to the internal logic of the operating system into the immersive environment also exists here.

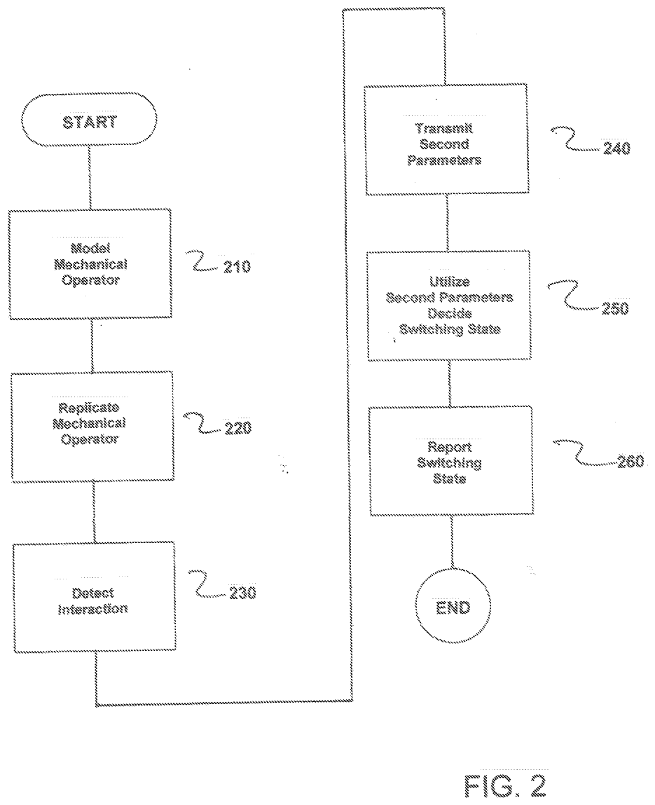

FIG. 2 is a flowchart of the method for immersive human computer interaction NI with a virtual mechanical operator of an industrial automation arrangement in virtual reality IU, where input information is transmitted to a component V-PLC of the industrial automation arrangement through interaction with the virtual mechanical operator. The method comprises modeling the mechanical operator in a simulation device STM for a rigid-body simulation, as indicated in step 210. Next, the mechanical operator in the is replicated in the virtual reality IU, as indicated in step 220.

Next, an interaction with the represented operator is detected by the virtual reality IU, as indicated in step 230. Here, second parameters F relating to a simulated physical effect on the operator are calculated from first parameters of the detected virtual interaction. Next, the second parameters are transmitted to the simulation device STM, as indicated in step 240.

Next, the second parameters F are utilized by the simulation device STM via the modelled operator to simulate a movement X of at least a part of the operator and whether a switching state change of the operator is produced by the simulated movement X is determined, as indicated in step 250.

Next, the switching state or switching state change is reported as the input information to the component V PLC at least when a switching state change occurs, as indicated in step 260.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for immersive human computer interaction with a virtual mechanical operator of an industrial automation arrangement in virtual reality, input information being transmitted to a component of the industrial automation arrangement through interaction with the operator, the method comprising:
modeling the mechanical operator in a simulation device for a rigid-body simulation;
replicating the mechanical operator in the virtual reality;
detecting an interaction with the represented operator by the virtual reality, second parameters relating to a simulated physical effect on the operator being calculated from first parameters of the detected virtual interaction;
transmitting the second parameters to the simulation device;
utilizing the second parameters by the simulation device via the modelled operator to simulate a movement of at least a part of the operator and deciding whether a switching state change of the operator is produced by the simulated movement; and
reporting the switching state or switching state change as the input information to the component at least when a switching state change occurs.

2. The method as claimed in patent claim 1, wherein a simulated mass-comprising body is utilized as the at least one part of the operator during the simulation; and wherein at least a force or a force-torque pair or other kinetic interaction dynamic is applied as the second parameters to the simulated mass-comprising body.

3. The method as claimed in claim 2, wherein the simulated mass-comprising body comprises one of (i) a lever, (ii) button, (iii) switch and (iv) other movable element.

4. The method as claimed in claim 1, wherein first values for a direction and a penetration of a hand or a finger are determined as the first parameters by the virtual reality with the replicated operator and are utilized to calculate the second parameters.

5. The method as claimed in claim 1, wherein the industrial automation arrangement comprises a device with a display screen output which is transmitted to the virtual reality and represented therein.

6. The method as claimed in claim 5, wherein the device comprises a simulated operating and monitoring device; wherein at least one of (i) inputs from the virtual reality and (ii) the input parameters transmitted during said reporting are utilized for the simulated operating and monitoring device; and wherein outputs of the simulated operating and monitoring device are transmitted to the virtual reality and are represented in the virtual reality with a replica of an operating and monitoring station.

7. The method as claimed in claim 1, wherein the component comprises a virtual programmable logic controller which executes an automation program intended for a real automation arrangement; wherein change requirements identified during execution of the program in the virtual programmable logic controller are utilized to correct the automation program; and wherein the changed automation program is used in the real automation arrangement.

8. The method as claimed in patent claim 7, wherein a process simulation device for an industrial process is connected to the virtual programmable logic controller; and wherein the virtual programmable logic controller at least one of (i) controls and (ii) monitors an industrial process simulated therewith via a bidirectional data exchange with the process simulation device.

9. The method as claimed in claim 1, wherein the second parameters or third parameters relating to the simulated movement are transmitted by the simulation device to the virtual reality, a representation of the operator being subsequently adapted by the virtual reality based on the transmitted parameters.

10. An arrangement for immersive human computer interaction with a virtual mechanical operator of an industrial automation arrangement in a virtual reality, the arrangement being configured to transmit input information to a component of the industrial automation arrangement as a result of the interaction with the virtual mechanical operator, the arrangement comprising:
a system for creating and visualizing the virtual reality, the mechanical operator being replicated in the virtual reality;
a simulation device for a rigid-body simulation of the virtual mechanical operator;
wherein the virtual reality is configured to detect the interaction with a represented virtual mechanical operator, second parameters relating to a simulated physical effect on the virtual mechanical operator being calculated from first parameters of the detected virtual interaction;
wherein the virtual reality is further configured to transmit the second parameters to the simulation device which is configured to simulate a movement of at least a part of the virtual mechanical operator via the modelled virtual mechanical operator based on the second parameters;
wherein the simulation device is configured to decide whether a switching state change of the virtual mechanical operator has been produced by the simulated movement; and
wherein the simulation device is further configured to report the switching state change or the switching state as the input information to the component at least when the switching state change occurs.

11. The arrangement as claimed in claim 10, wherein the virtual mechanical operator has a simulated mass-comprising body in the simulation device; and wherein the simulation device is further configured to apply at least one of (i) a force, (ii) a force-torque pair and (iii) other kinetic interaction dynamic as second parameters to the simulated mass-comprising body.

12. The arrangement as claimed in claim 11, wherein the simulated mass-comprising body comprises one of (i) a lever, (ii) a button and (iii) switch.

13. The arrangement as claimed in claim 10, wherein the industrial automation arrangement comprises a device with a display screen output which transmits the display screen output to the virtual reality and represents said display screen output therein.

14. The arrangement as claimed in claim 11, wherein the industrial automation arrangement comprises a device with a display screen output which transmits the display screen output to the virtual reality and represents said display screen output therein.

15. The arrangement as claimed in claim 10, wherein the device comprises a simulated operating and monitoring device which utilizes at least one of (i) inputs from the virtual reality and (ii) the input parameters transmitted during said reporting for the simulated operating and monitoring device, and the device transmit outputs of the simulated operating and monitoring device to the virtual reality and represent said transmitted output in the virtual reality with a replica of an operating and monitoring station.

16. The arrangement as claimed in claim 10, wherein the component comprises a virtual programmable logic controller which comprises an automation program for a real automation arrangement; and wherein change requirements identified are utilized in execution of the program in the virtual programmable logic controller to correct the automation program, and the corrected automation program is utilized in the real automation arrangement.

17. The arrangement as claimed in claim 16, further comprising:
a process simulation device for an industrial process connected to the virtual programmable logic controller;
wherein the virtual programmable logic controller is configured to at least one of (i) control and (ii) monitor an industrial process simulated via a bidirectional data exchange with the process simulation device.

18. The arrangement as claimed in claim 10, wherein the simulation device is further configured to transmit one of (i) the second parameters and (ii) third parameters relating to the simulated movement to the virtual reality, a representation of the virtual mechanical operator being subsequently adapted by the virtual reality based on the transmitted parameters.

19. The arrangement as claimed in claim 10, further comprising:
a separate computing device having at least one of (i) separate hardware and (ii) separate software in order to create the virtual reality.
